(19) United States
(12) Patent Application Publication
(10) Pub. No.: US 2015/0239614 A1
(43) Pub. Date: Aug. 27, 2015

(54) SNAP-ON CONTAINER LABELING SYSTEM

(71) Applicant: Nitin Aeri, Hoboken, NJ (US)

(72) Inventor: Nitin Aeri, Hoboken, NJ (US)

(21) Appl. No.: 14/190,522

(22) Filed: Feb. 26, 2014

(51) Int. Cl. B65D 25/20; G09F 3/02

(52) U.S. Cl. CPC B65D 25/205; G09F 3/02; G09F 2003/0272

(57) ABSTRACT

The present invention comprises a container labeling system utilizing snap-on tabs containing labels, text, or other material used to identify the contents of various different containers which may be of various sizes, including bottles and cans. A substantially cylindrical elastic band is placed around each container which is to be labeled. Snap-on tabs are attached to the band by inserting the band into a semi-cylindrical groove extending across the back of each snap-on tab. The shape and width of the groove is configured to allow the band to be readily snapped into the groove, and to allow the band to be readily removed from the groove when required. The shape of the snap-on tabs are substantially rectangular in some embodiments, or substantially square in other embodiments. Labels identifying the contents of each container are attached to the front surfaces of the snap-on tabs.

### CROSS REFERENCE TO RELATED APPLICATION(S)

Not Applicable.

### FIELD OF INVENTION

This invention relates to container labeling systems, and in particular to a snap-on container labeling system.

### BACKGROUND

A group of containers with similar appearances may each contain different materials or substances. A need may often arise to easily and effectively label each container in the group with relevant information such as the contents of the containers, without causing permanent damage to the containers. For example, a group of similar appearing baby bottles may contain different contents in each bottle, thus requiring the bottles to be labeled with the details of their contents and the details of their owners.

Various systems have been devised for conveniently labeling the contents of various types of containers and cylindrical shaped objects of various sizes including bottles, cans, jars, and pill containers. These labeling systems may utilize printed stickers from a label maker, hand written text on tape, permanent marker applied directly on containers, and the like. These labeling systems may lack certain desirable features such as being easily customizable, being esthetically pleasing, and being simple to use without causing any permanent damage to the container being labeled.

Therefore, there is a need for an easy to implement system for easily and effectively labeling containers of different size. The present invention comprises a container labeling system utilizing snap-on tabs which include labels, text, or other figures which provide useful information regarding containers. The snap-on tabs with their labels may be easily attached and detached to an elastic band which encircles each container. The snap-on labeling system accomplishes the objective of conveniently labeling various containers of different sizes with customizable labels without causing permanent damage to the containers.

### SUMMARY

The present invention comprises a container labeling system utilizing snap-on tabs which include labels, text, or other figures which provide useful information regarding a container such as identifying the contents and owner of the container.

A substantially cylindrical elastic band, which may be comprised of materials such as silicone, is placed around each container which is to be labeled. Snap-on tabs are attached to the band by pressing the band into a groove on each snap-on tab, thereby securing the snap-on tab onto the band. The shape and width of the groove is configured to allow the band to be readily snapped into the groove, and to allow the band to be readily removed from the groove when required. When needed to be removed, the snap-on tabs can be easily pulled off the band. Each snap-on tab includes several surfaces including a side surface, a back surface, a front surface, and vertical end surfaces.

The snap-on tabs will come with labels. In some embodiments of the invention the labels will be comprised of a perforated sheet of stickers which are printed individually with the alphabet and numbers. The customer will remove the labels they wish to utilize, and will attach them to the front surfaces of the respective snap-on tabs. The labels will then provide useful information such as the identity of the container owner, the container contents, special instructions for the contents of the container, and the like.

The shape of the snap-on tabs is substantially rectangular in some embodiments, or substantially square in other embodiments of the invention. The snap-on tab includes vertical end surfaces, side surfaces, and a back surface.

The invention described herein may be commonly utilized with baby bottles and baby food containers, but may also be utilized with a variety of other containers including, but not limited to rectangular and circular containers and the like. The invention and its components may be provided in a variety of sizes to accommodate various sized containers. The invention may be constructed of man-made materials such as various plastics.

While embodiments of the invention have been described in detail above, the invention is not limited to the specific embodiments described above, which should be considered as merely exemplary. Further modifications and extensions of the invention may be developed, and all such modifications are deemed to be within the scope of the invention.

Other features and advantages of the present invention will become apparent from the following more detailed description, taken in conjunction with the accompanying drawings, which illustrate, by way of example, the principles of the invention.

### BRIEF DESCRIPTION OF THE DRAWING(S)

The foregoing Summary as well as the following detailed description will be readily understood in conjunction with the appended drawings which illustrate embodiments of the invention. In the drawings:

FIG. 1 is a top perspective view of the present invention including a snap-on label system;

FIG. 2 is a front view of the present invention including a snap-on label system;

FIG. 3 is a back perspective view of the present invention including a snap-on tab;

FIG. 4 is a front perspective view of the present invention including a snap-on tab.

### DETAILED DESCRIPTION OF ILLUSTRATIVE EMBODIMENT(S)

The present invention comprises a container labeling system 10 utilizing snap-on tabs 26 which include labels 24, text, or other figures which provide useful information regarding a container such as identifying the contents and owner of the container.

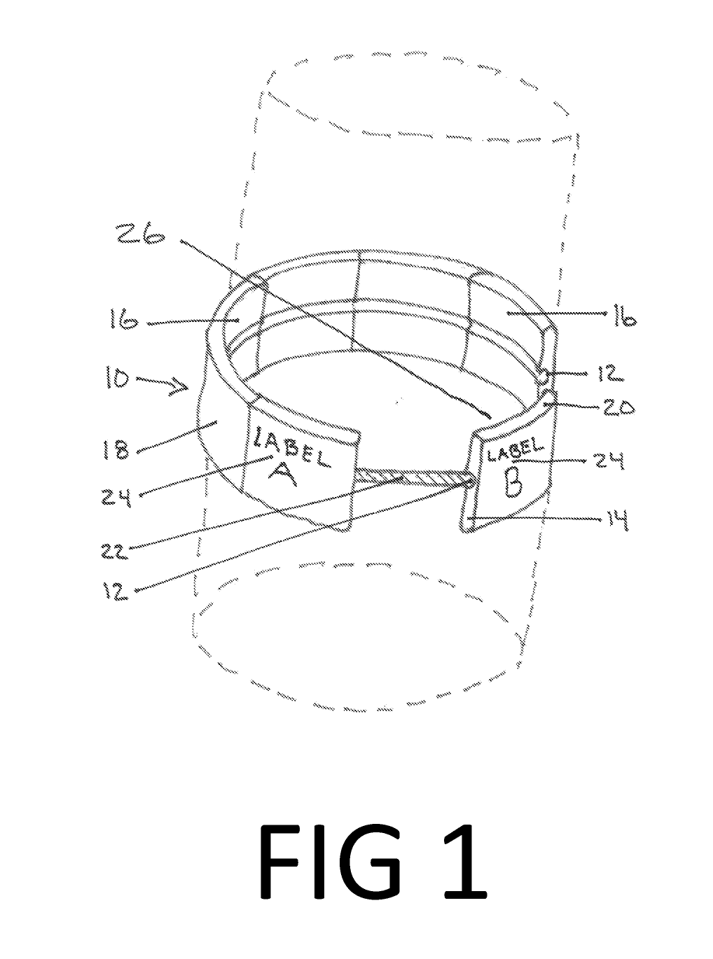

Referring now to FIG. 1, a container labeling system 10 installed on a container is illustrated. A substantially cylindrical elastic band 22, which may be comprised of various materials including silicone, is placed around each container that requires label(s). The container owner secures the snap-on tabs 26 to the band 22 by pressing the band 22 into a groove 12 on each snap-on tab 26. When the container owner needs to remove the snap-on tabs 26, they can be easily pulled off the band 22. In some embodiments of the invention 10, each snap-on tab 26 may be substantially rectangular and will include a side surface 14, a back surface 16, a front surface 18, and vertical end surfaces 20.

Some embodiments of the invention may include various types of labels 24 that the container owner attaches to the snap-on tabs 26. The labels 24 may be comprised of perforated stickers 24 or the like, which are printed individually with the alphabet and numbers. In these embodiments the container owner will remove the labels 24 they wish to utilize, and will attach them to the front surfaces 18 of the respective snap-on tabs 26. The labels 24 will then provide useful information such as the identity of the container owner, the container contents, special instructions for the contents of the container, and the like.

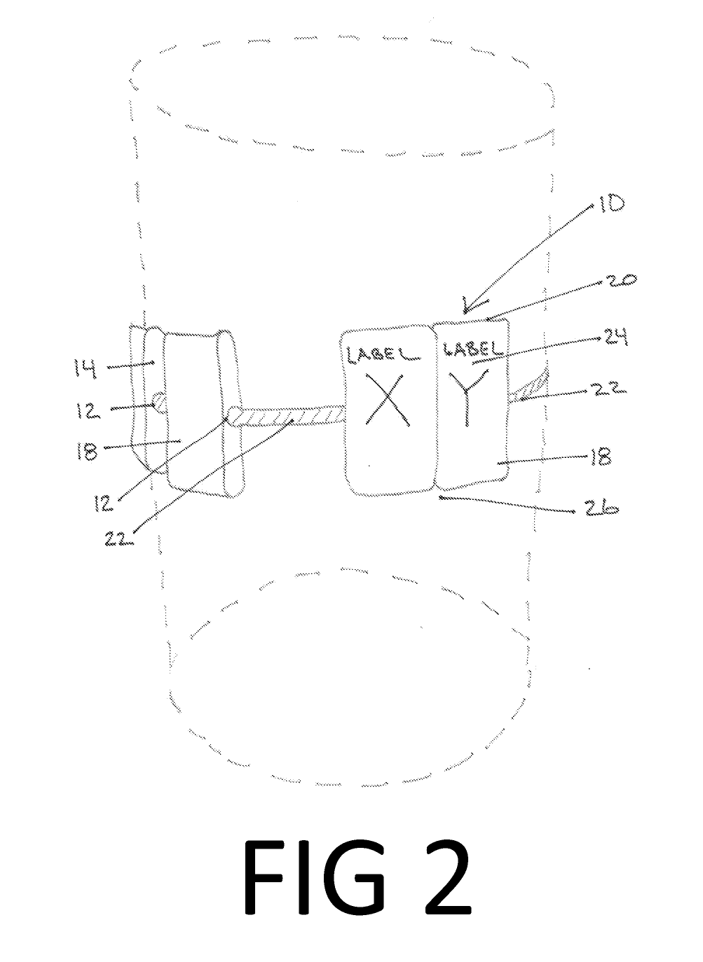

In FIG. 2 is illustrated a front view of the snap-on container labeling system 10. The elastic band 22 has been installed on a container for which the owner requires label(s). The band 22 is inserted into the groove 12 running through each snap-on tab 26. Each snap-on tab includes a front surface 18, a side surfaces 14, a back surface 16, and vertical end surfaces 20. The labels 24 on each snap-on tab 26 identify the contents of each container.

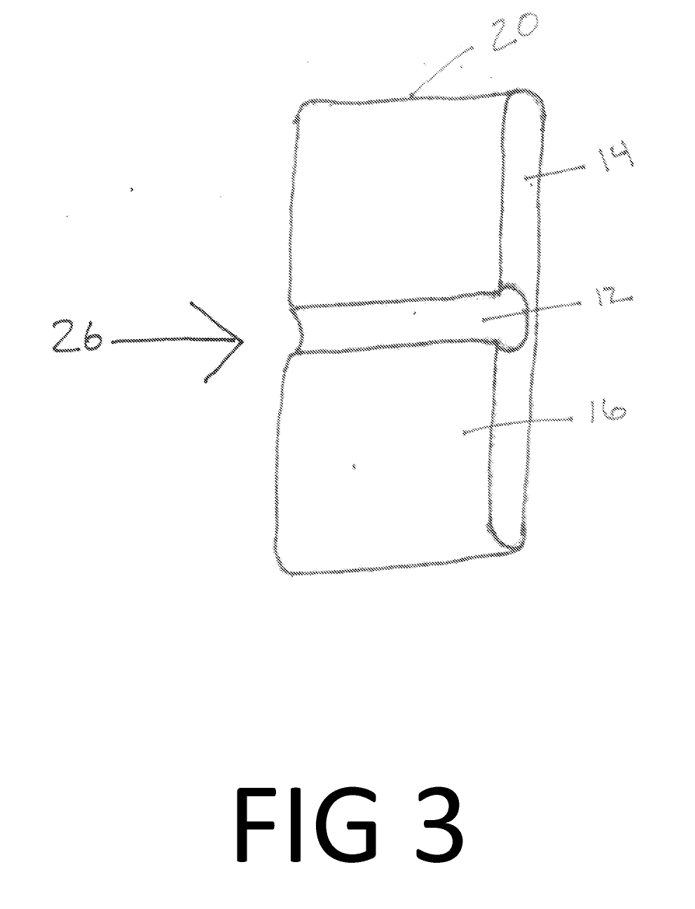

In FIG. 3 is illustrated a back perspective view of one embodiment of a snap-on tab 26. The shape of the snap-on tab 26 is substantially rectangular in some embodiments, or substantially square in other embodiments of the invention 10. The snap-on tab 26 includes vertical end surfaces 20, side surfaces 14, and a back surface 16. In some embodiments of the invention 10, the back surface 16 of the snap-on tab 26 may be substantially flat, while in other embodiments of the invention 10 the back surface 16 of the snap-on tab 26 may be contoured to approximately match the shape of the container.

The semi-cylindrical groove 12 extends horizontally across the back surface 16 of the snap-on tab 26, the groove 12 being located approximately half way between the vertical ends 20 of the snap-on tab 26. The shape and width of the groove 12 is configured to allow the band 22 to be readily snapped into the groove 12, and to allow the band 22 to be readily removed from the groove 12 when required.

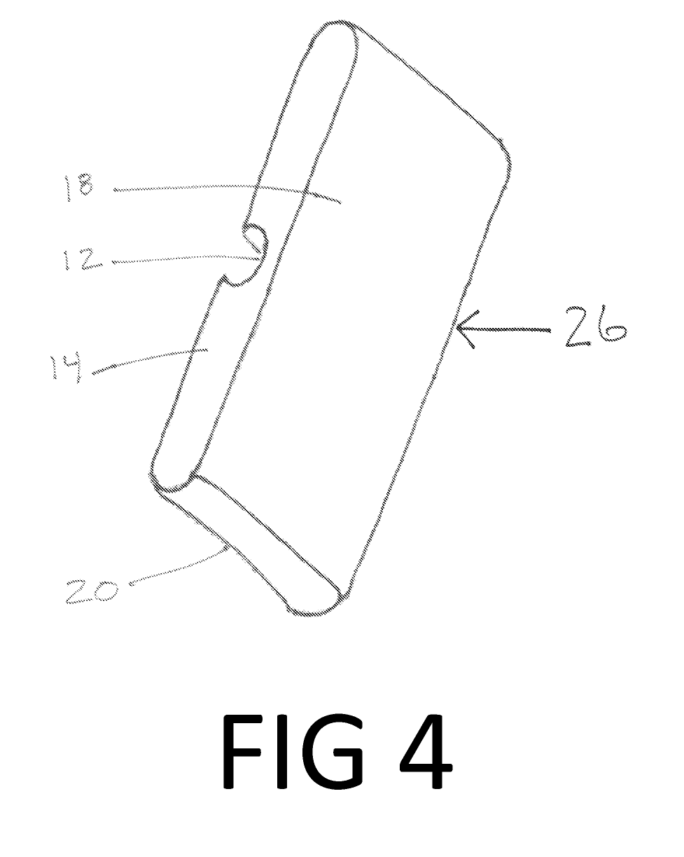

Turning now to FIG. 4, a front perspective view of one embodiment of a snap-on tab 26 is illustrated. The shapes of the snap-on tabs 26 may be substantially rectangular in some embodiments of the invention 10, or may be substantially square in other embodiments of the invention 10. The snap-on tab 26 includes vertical end surfaces 20, side surfaces 14, and a front surface 18. The end of the semi-cylindrical groove 12 is shown on the side surface 14, located approximately half way between the vertical ends 20 of the snap-on tab 26.

The invention 10 described herein may be commonly utilized with baby bottles and baby food containers, but may also be utilized with a variety of other containers including, but not limited to rectangular and circular containers and the like. The invention 10 and its components may be provided in a variety of sizes to accommodate various sized containers.

The invention 10 may be constructed of man-made materials such as various plastics.

While embodiments of the invention 10 have been described in detail above, the invention 10 is not limited to the specific embodiments described above, which should be considered as merely exemplary illustrations set forth for a clear understanding of the principles of the invention 10. Further variations, modifications, extensions, or equivalents of the invention 10 may be developed without departing from the scope of the invention 10. It is therefore intended that the invention 10 not be limited to the particular embodiments disclosed as the best mode contemplated for carrying out this invention 10, but that the invention 10 will include all the embodiments falling within the scope of the appended claims.

What is claimed is:

1. A removable labeling system for identifying containers, comprising:
a removable elongated band configured to fit around a container;
a plurality of tabs having a front surface and a back surface;
grooves configured on the back surfaces of said tabs;
container information configured on said front surfaces of said tabs.

2. The removable labeling system of claim 1, wherein said container information is comprised of attachable labels.

3. The removable labeling system of claim 1, wherein the shape of said groove is configured so that said tab can be attached to said band.

4. The removable labeling system of claim 1, wherein the shape of said grooves is semi-cylindrical.

5. The removable labeling system of claim 1, wherein said elongated band is comprised of an elastic material.

6. The removable labeling system of claim 1, wherein said grooves are configured so that said tabs may be snapped securely onto said elongated band.

7. The removable labeling system of claim 1, wherein the shape of said front surfaces and said back surfaces is substantially rectangular.

8. The removable labeling system of claim 1, wherein the shape of said front surfaces and said back surfaces is substantially square.

9. The removable labeling system of claim 1, wherein said tabs are comprised of plastic materials.

10. A removable labeling system for identifying containers, comprising:
a removable elongated elastic band configured to fit around a container;
a plurality of substantially rectangular tabs having front surfaces and a back surfaces;
grooves configured on said back surfaces to allow said tabs to be attached to said band;
labels configured to attach to said tabs;
container information configured on said labels.

11. A removable labeling system for identifying containers, comprising:
a removable elongated elastic band configured to fit around a container;
a plurality of substantially square tabs having front surfaces and back surfaces;
grooves configured on said back surfaces to allow said tabs to be attached to said band;
container information configured on said labels.
